(19) United States
(12) Patent Application Publication
(10) Pub. No.: US 2006/0253870 A1
(43) Pub. Date: Nov. 9, 2006

(54) Reserved recording of broadcast programs

(76) Inventor: Sun-Hee Lee, Yongin-si (KR)

Correspondence Address: Robert E. Bushnell, Suite 300, 1522 K Street, N.W., Washington, DC, 20005, US

(21) Appl. No.: 11/397,854

(22) Filed: Apr. 5, 2006

(30) Foreign Application Priority Data
May 6, 2005 (KR) 10-2005-0038153

(51) Int. Cl. H04N 5/445

(52) U.S. Cl. 725/58

(57) ABSTRACT

A system and method of reserved recording of a broadcast program includes: a set-top box storing broadcast program information and setting up reserved recording of the broadcast program in response to a reserved recording request; and a wireless transceiver receiving the broadcast program information from the set-top box and displaying the received broadcast program information on a display, and generating a reserved recording request signal including information of the broadcast program selected by a user for reserved recording and transmitting the generated signal to the set-top box.

### CLAIM OF PRIORITY

This application makes reference to, incorporates the same herein, and claims all benefits accruing under 35 U.S.C. §119 from an application for SYSTEM AND METHOD FOR RESERVED RECORDING OF BROADCAST PROGRAM earlier filled in the Korean Intellectual Property Office on 6 May 2005 and there duly assigned Serial No. 2005-38153.

### BACKGROUND OF THE INVENTION

1. Field of the Invention

The present invention relates to a system and method for reserved recording of broadcast programs.

2. Description of Related Art

In order to watch television (TV), people generally turn on a TV set and change the channel until a desired TV program is received, or remember the time a program is broadcast by referring to a lineup of TV programs appearing in a newspaper, etc. and tune in the program at the appropriate time. In order to record broadcast programs, a Video Cassette Recorder (VCR) connected to a TV set is used. One way to record a program is to change a VCR channel to a channel of a desired program and begin recording. When a time and a channel for reserved recording have been set in a VCR, a corresponding program is automatically recorded even when no one is watching the TV or everyone is outside.

Korean Patent Application No. 10-2001-0030623 entitled “Method for TV Program Recording Reservation Using the Internet” discloses a TV program reserved recording service providing a method using the Internet for reserved recording and playback at a remote location away from home. The TV program reserved recording service system using the Internet includes: an Internet web server having TV program information from the Internet allowing a subscriber to confirm and select a TV program, personal information on the subscriber and Internet address information (an Internet Protocol (IP) address) of the subscriber's recorder; a digital video recorder/player that is connected to the Internet and receives reservation information of the TV program that the subscriber has selected in order to record and store the TV program at the assigned time; and a TV set showing the TV program recorded by the digital video recorder/player.

However, the conventional TV program reserved recording service method requires a separate web server using an IP method and storing broadcast program information and so on. In addition, there are security issues due to the use of the Internet.

### SUMMARY OF THE INVENTION

It is an object of the present invention to provide a broadcast program reserved recording system and method that can easily record a broadcast program by transmitting simple Electronic Program Guide (EPG) information to a wireless transceiver, such as a remote controller, through an information interchange between the wireless transceiver and a set-top box, without turning on a TV for reserved recording, in order to perform a reserved recording operation using the wireless transceiver in one's own house which is different from the conventional method of performing reserved recording at a remote site.

According to one aspect of the present invention, a system is provided including: a set-top box adapted to store broadcast program information and to set up a reserved recording of the broadcast program in response to a reserved recording request; and a wireless transceiver adapted to receive the broadcast program information from the set-top box and to display the received broadcast program information on a display, and to generate a reserved recording request signal including information of the broadcast program selected by a user for reserved recording and to transmit the generated reserved recording request signal to the set-top box.

The set-top box preferably includes: a first module adapted to encode and then transmit a broadcast program information signal to the wireless transceiver, and to receive and then decode the reserved recording request signal; a second module adapted to store broadcast program information corresponding to the broadcast program information signal encoded by the first module and to transmit it to the wireless transceiver; and a third module adapted to set up the reserved recording of a broadcast program corresponding to the reserved recording request signal received from the wireless transceiver and decoded by the first module.

The wireless transceiver preferably includes: a first module adapted to receive a broadcasting information signal from the set-top box and to decode the received signal, and to encode the reserved recording request signal and to transmit the encoded signal to the set-top box; a second module adapted to store the broadcast program information signal received from the set-top box and decoded by the first module; a third module adapted to display broadcast program information corresponding to the broadcast program information signal stored in the second module on the display; and a fourth module adapted to receive information of the broadcast program selected by the user of the wireless transceiver for reserved recording from among the broadcast program information displayed on the display by the third module.

The wireless transceiver preferably includes one of an infrared remote controller, a cellular telephone, and a Personal Digital Assistant (PDA).

The wireless transceiver preferably employs one of a Wireless Local Area Network (WLAN), a Bluetooth system, and an Ultra Wide Band (UWB) system.

The broadcast program information preferably includes Electronic Program Guide (EPG) information. The information of the broadcast program selected by the user for reserved recording preferably includes at least one of a reserved recording program identification, a recording frequency, a reserved recording start time, and a reserved recording duration.

According to another aspect of the present invention, a set-top box is provided including: a first module adapted to encode a broadcast program information signal and to transmit the encoded signal to a wireless transceiver, and to receive and decode a reserved recording request signal from the wireless transceiver; a second module adapted to store broadcast program information corresponding to the broadcast program information signal encoded by the first module and transmitted to the wireless transceiver; and a third module adapted to set up a reserved recording of a broadcast program corresponding to the reserved recording request signal received from the wireless transceiver and decoded by the first module.

According to still another aspect of the present invention, a wireless transceiver is provided including: a first module adapted to receive a broadcasting information signal from a set-top box and to decode the received signal, and to encode a reserved recording request signal and to transmit the encoded signal to the set-top box; a second module adapted to store the broadcast program information signal received from the set-top box and decoded by the first module; a third module adapted to display broadcast program information corresponding to the broadcast program information signal stored in the second module on a display; and a fourth module adapted to receive information of a broadcast program selected by a user of the wireless transceiver for reserved recording from among the broadcast program information displayed on the display by the third module.

According to yet another aspect of the present invention, a method is provided including: generating, at a wireless transceiver, a broadcast program information request signal and transmitting the generated signal to a set-top box in response to a program search request input by a user; transmitting, at the set-top box, broadcast program information to the wireless transceiver in response to the broadcast program information request signal; outputting, at the wireless transceiver, the received broadcast program information on a display portion; receiving, at the wireless transceiver, information of a broadcast program selected by the user for reserved recording, generating a reserved recording request signal, and transmitting the generated signal to the set-top box; and setting up, at the set-top box, reserved recording of the broadcast program corresponding to the reserved recording program information included in the reserved recording request signal.

The program search request is preferably effected by one of a program name and a channel number.

The broadcast program information preferably includes EPG information. The broadcast program information is preferably displayed on the display of the wireless transceiver in a text format.

The reserved recording program information preferably includes at least one of a reserved recording program identification, a recording frequency, a reserved recording start time, and a reserved recording duration.

According to a further aspect of the present invention, a method is provided including: generating a broadcast program information request signal and transmitting the generated signal to a set-top box in response to a program search request input by a user of a wireless transceiver; receiving broadcast program information from the set-top box; displaying the received broadcast program information on a display; receiving information of a broadcast program selected by the user of the wireless transceiver for reserved recording from among the broadcast program information displayed on the display, and generating a reserved recording request signal and transmitting the generated signal to the set-top box; and setting a reserved recording of the broadcast program corresponding to the reserved recording program information included in the transmitted reserved recording request signal by the set-top box.

According to another aspect of the present invention, a method is provided including: receiving a broadcast program information request signal from a wireless transceiver; extracting information of a broadcast program corresponding to the broadcast program information request signal from a program information database prepared in advance; transmitting the extracted broadcast program information to the wireless transceiver; receiving a reserved recording request signal from the wireless transceiver, the reserved recording request signal being generated on the basis of information of a broadcast program selected by a user of the wireless transceiver for reserved recording from among the transmitted broadcast program information; and setting up reserved recording of the broadcast program corresponding to the reserved recording program information included in the received reserved recording request signal.

### BRIEF DESCRIPTION OF THE DRAWINGS

A more complete appreciation of the present invention, and many of the attendant advantages thereof, will be readily apparent as the present invention becomes better understood by reference to the following detailed description when considered in conjunction with the accompanying drawings in which like reference symbols indicate the same or similar components, wherein:

FIG. 1 is a block diagram of a broadcast program reserved recording system according to an exemplary embodiment of the present invention;

FIG. 2 is a flowchart of a broadcast program reserved recording method according to an exemplary embodiment of the present invention;

FIG. 3 is a block diagram of a set-top box according to an exemplary embodiment of the present invention;

FIG. 4 is a block diagram of a wireless transceiver according to an exemplary embodiment of the present invention;

FIG. 5 is view of a wireless transceiver according to an exemplary embodiment of the present invention;

FIG. 6A is a flowchart of a process of searching for a broadcast program by channel number according to an exemplary embodiment of the present invention;

FIG. 6B is a flowchart of a process of searching for a broadcast program by program name according to an exemplary embodiment of the present invention;

FIG. 7A is a view of a process of a wireless transceiver according to an exemplary embodiment of the present invention communicating with a set-top box to receive broadcast program information;

FIG. 7B is a view of a Program_Req( ) according to an exemplary embodiment of the present invention;

FIG. 7C is a view of a Program_Rsp( ) according to an exemplary embodiment of the present invention;

FIG. 7D is a view of a Program_Ack( ) according to an exemplary embodiment of the present invention;

FIG. 8A is a view of a process of a set-top box according to an exemplary embodiment of the present invention communicating with a wireless transceiver to receive broadcast program information;

FIG. 8B is a view of a Program_Rec_Req( ) according to an exemplary embodiment of the present invention;

FIG. 8C is a view of a Program_Rec_Rsp( ) according to an exemplary embodiment of the present invention; and

FIG. 8D is a view of a Program_Rec_Ack( ) according to an exemplary embodiment of the present invention.

### DETAILED DESCRIPTION OF THE INVENTION

Hereinafter, exemplary embodiments of the present invention are described in detail with reference to the accompanying drawings. Like elements are denoted by like reference numerals throughout the drawings. Matters related to the present invention and well-known in the art have not been described in detail when such a description would detract from the clarity of the disclosure.

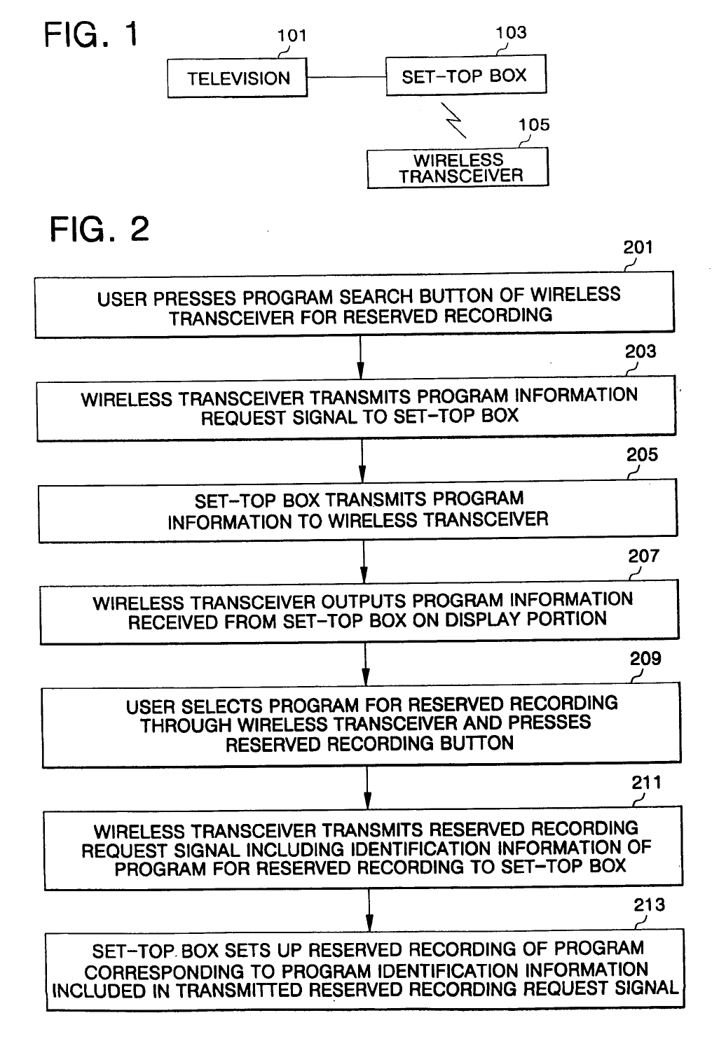

FIG. 1 is a block diagram of a broadcast program reserved recording system according to an exemplary embodiment of the present invention.

Referring to FIG. 1, the broadcast program reserved recording system includes a TV 101, a set-top box 103, and a wireless transceiver 105.

The set-top box 103 includes a database of broadcast program information, and sets up a reserved recording of a broadcast program corresponding to reserved recording program information included in a reserved recording request signal transmitted from the wireless transceiver 105.

In addition, the wireless transceiver 105 can receive broadcast program information from the set-top box 103, output it on a display, and generate the reserved recording request signal in response to information of the broadcast program selected by a user for reserved recording and transmitting it to the set-top box 103.

FIG. 2 is a flowchart of a broadcast program reserved recording method according to an exemplary embodiment of the present invention.

Referring to FIG. 2, a user of a wireless transceiver 105 presses a program search button for reserved recording (step 201). The wireless transceiver 105 then transmits a program 8 information request signal to a set-top box 103 (step 203). The set-top box 103 then transmits program information to the wireless transceiver 105 (step 205). The wireless transceiver 105 displays the program information received from the set-top box 103 on a display thereof (step 207). Subsequently, the user of the wireless transceiver 105 selects a program for reserved recording through the wireless transceiver 105 and presses a reserved recording button (step 209). The wireless transceiver 105 then transmits a reserved recording request signal including identification information of the program for reserved recording to the set-top box 103 (step 211). The set-top box 103 sets up a reserved recording of the program corresponding to the program identification information included in the transmitted reserved recording request signal (step 213).

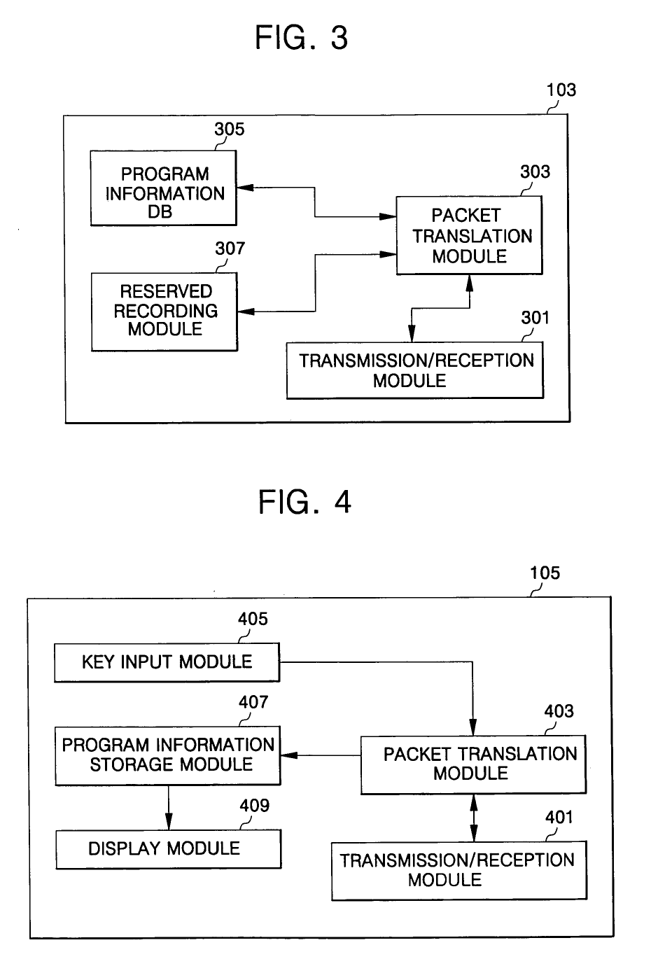

FIG. 3 is a block diagram of a set-top box 103 according to an exemplary embodiment of the present invention.

Referring to FIG. 3, the set-top box 103 includes a transmission/reception module 301, a packet translation module 303, a program information database 305, and a reserved recording module 307.

The transmission/reception module 301 enables the set-top box 103 to transmit or receive a signal from the wireless transceiver 105. In addition, the packet translation module 303 is used to encode a signal to be transmitted by the set-top box 103 to the wireless transceiver 105 or to decode a signal received from the wireless transceiver 105.

In addition, the program information database 305 receives and stores various channel information and broadcast program information for digital broadcasting. The broadcast program information stored in the program information database 305 corresponds to an EPG.

The reserved recording module 307 sets up a reserved recording of a broadcast program corresponding to the reserved recording program information included in a reserved recording request signal received from the wireless transceiver 105.

FIG. 4 is a block diagram of a wireless transceiver 105 according to an exemplary embodiment of the present invention.

Referring to FIG. 4, the wireless transceiver 105 includes a transmission/reception module 401, a packet translation module 403, a key input module 405, a program information storage module 407, and a display module 409.

The wireless transceiver 105 can be an infrared remote controller, a cellular telephone, and a Personal Digital Assistant (PDA), and can employ Bluetooth, Ultra Wide Band (UWB), or the like.

In addition, the transmission/reception module 401 enables the wireless transceiver 105 to transmit a signal to or receive a signal from the set-top box 103. The packet translation module 403 is used to encode a signal to be transmitted by the wireless transceiver 105 to a set-top box 103 or to decode a signal received from the wireless transceiver 105.

In addition, the key input module 405 enables a user of the wireless transceiver 105 to select a broadcast program for reserved recording.

The program information storage module 407 stores broadcast program information that the wireless transceiver 105 receives from a set-top box 103. The broadcast program information is displayed by the display module 409 on a display in a text format.

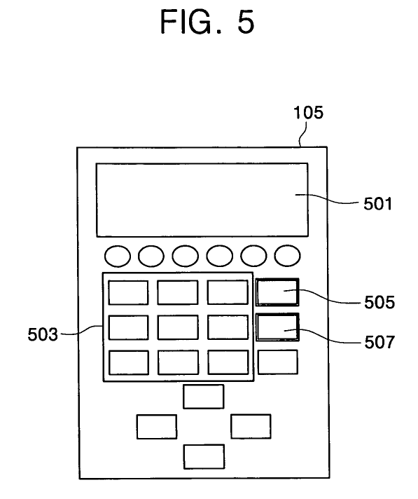

FIG. 5 is view of a wireless transceiver 105 according to an exemplary embodiment of the present invention.

Referring to FIG. 5, the wireless transceiver 105 includes a display 501, a character input portion 503, a search request button 505, and a reserved recording request button 507.

The search request button 505 enables a user of the wireless transceiver 105 to search for a broadcast program. The character input portion 503 enables a user to input a name of a broadcast program when a user of the wireless transceiver 105 wants to search for a broadcast program by program name.

In addition, the display 501 enables the wireless transceiver 105 to display broadcast program information received from a set-top box 103. The reserved recording request button 507 enables a user of the wireless transceiver 105 to look at the broadcast program information output on the display 501 to select a broadcast program that the user wants to reserved record.

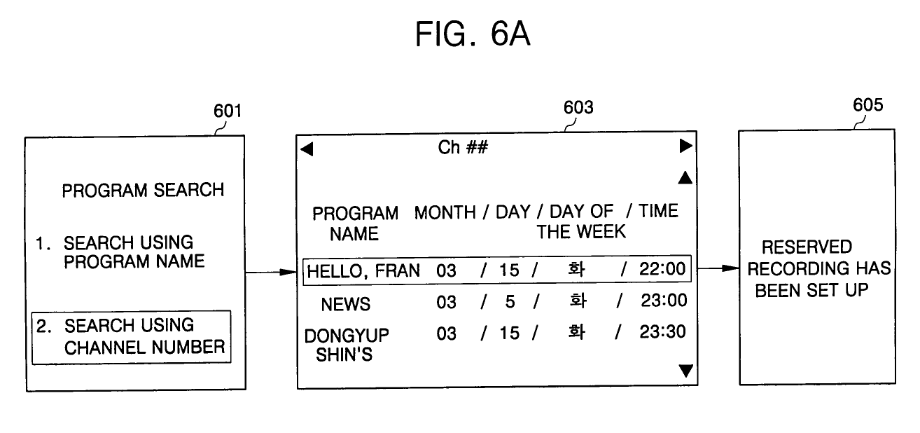

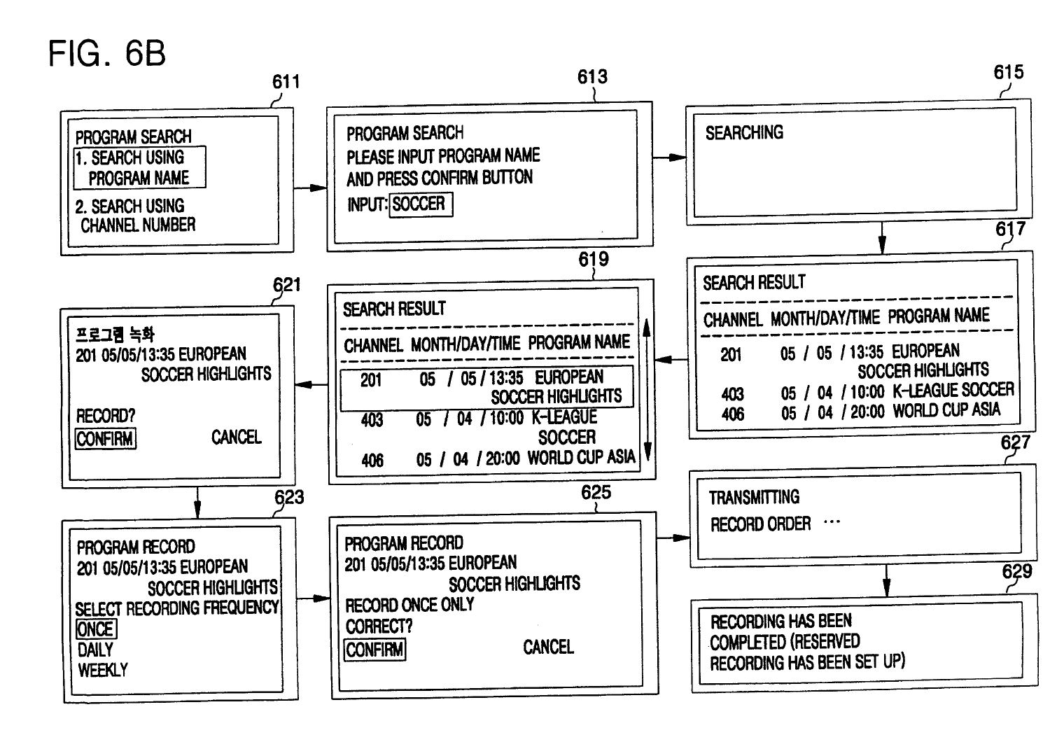

FIG. 6A is a flowchart of a process of searching for a broadcast program by channel number according to an exemplary embodiment of the present invention.

Referring to FIG. 6A, when a user of the wireless transceiver 105 presses the search request button 505, a program search menu screen 601 is displayed on the display 501. The program search menu screen 601 includes an item for searching for a broadcast program by program name and an item for searching for a broadcast program by channel number.

When the user of the wireless transceiver 105 selects the item for searching by channel number, the wireless transceiver 105 communicates with the set-top box 103 to collect information of a program list of a selected channel and displays a program list screen 603 on the display 501.

When the user of the wireless transceiver 105 selects a specific program, e.g., “Hello, Fran . . . ,” the wireless transceiver 105 generates and transmits a reserved recording request signal for the specific program to the set-top box 103, so that reserved recording of the specific program can be set up in the set-top box 103.

Subsequently, the wireless transceiver 105 communicates with the set-top box 103 to display a reserved recording set up confirmation screen 605 on the display 501.

FIG. 6B is flowchart of a process of searching for a broadcast program by program name according to an exemplary embodiment of the present invention.

Referring to FIG. 6B, when a user of the wireless transceiver 105 presses the search request button 505, a program search menu screen 611 is displayed on the display 501. The program search menu screen 611 includes an item for searching by program name and an item for searching by channel number.

When the user of the wireless transceiver 105 selects the item for searching for a broadcast program by program name, the wireless transceiver 105 displays a program name input screen 613 on the display 501. The user of the wireless transceiver 105 then inputs a broadcast program name, e.g., “soccer,” that the user wants to search for through the program name input screen 613.

The wireless transceiver 105 then communicates with the set-top box 103 to collect information about broadcast programs including the inputted characters. The wireless transceiver 105 displays a searching screen 615 on the display 501.

Subsequently, when the wireless transceiver 105 has completely received the broadcast program information from the set-top box 103, it displays a search result list screen 617 on the display 501.

The user of the wireless transceiver 105 selects a broadcast program for reserved recording through a reserved recording program selection screen 619. Then, the wireless transceiver 105 displays a reserved recording program confirmation screen 621 on the display 501.

Subsequently, when the user of the wireless transceiver 105 confirms the reserved recording program through the reserved recording program confirmation screen 621, the wireless transceiver 105 displays a recording frequency selection screen 623 on the display 501. When the user of the wireless transceiver 105 then selects a recording frequency, e.g., “once,” through the recording frequency selection screen 623, the wireless transceiver 105 displays a frequency confirmation screen 625 on the display 501.

When the user of the wireless transceiver 105 confirms the recording frequency through the frequency confirmation screen 625, the wireless transceiver 105 generates a reserved recording request signal based on the collected information of the reserved recording program, the recording frequency, and so on, and transmits it to the set-top box 103. The wireless transceiver 105 can display a reserved recording request screen 627 on the display 501.

Subsequently, the wireless transceiver 105 communicates with the set-top box 103 to display a reserved recording set up confirmation screen 629 on the display 501.

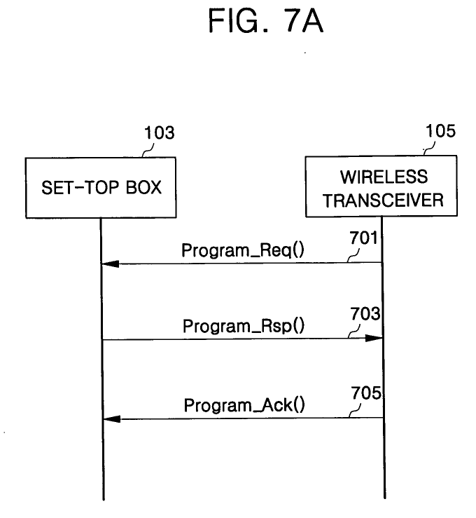

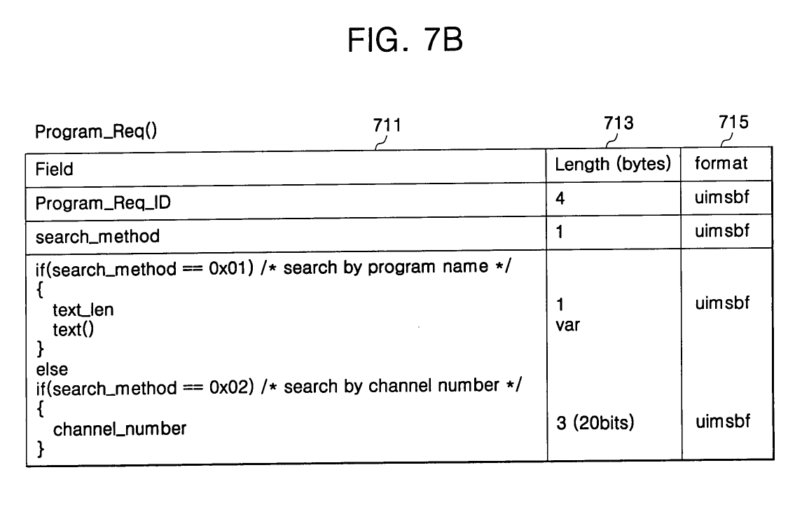

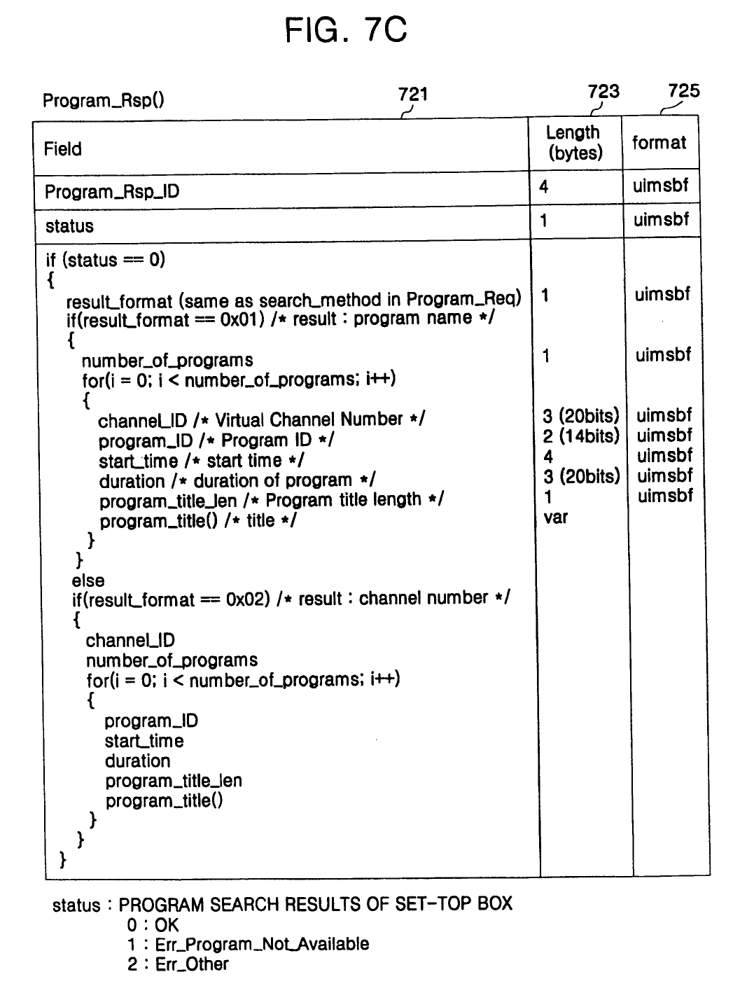

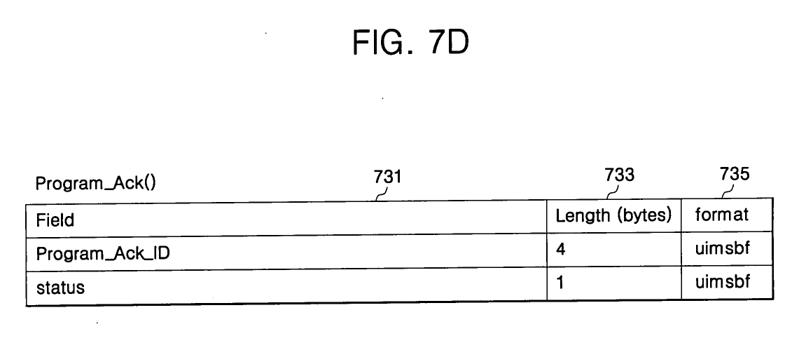

FIG. 7A is a flowchart of a process of a wireless transceiver 105 communicating with a set-top box 103 to receive broadcast program information according to an exemplary embodiment of the present invention.

Referring to FIG. 7A, a message can be exchanged between the wireless transceiver 105 and the set-top box 103 by a three-way handshake method. In other words, messages can be exchanged in a sequence of request, response, and acknowledgement. In addition, the protocol can comprise Packet Data Units (PDUs).

When the user of the wireless transceiver 105 requests the broadcast program information, the wireless transceiver 105 transmits Program_Req( ) to the set-top box 103 (step 701). In response, the set-top box 103 transmits Program_Rsp( ) corresponding to the requested broadcast program information to the wireless transceiver 105 (step 703). The wireless transceiver 105 then delivers a confirmation message to the set-top box 103 by transmitting Program_Ack( ) (step 705).

FIG. 7B is a view of a Program_Req( ) according to an exemplary embodiment of the present invention.

Referring to FIG. 7B, a software program corresponding to the Program_Req( ) is shown in a column “Field”, length of data in the software program is shown in a column “Length”, and format of data is shown in the column “format”.

According to the software program corresponding to the Program_Req( ), when a broadcast program search method selected by a user is a search method using a program name, the name is typed in by the user, and when the broadcast program search method selected by the user is a search method using a channel number, the corresponding number is input by the user.

FIG. 7C is a view of a Program_Rsp( ) according to an exemplary embodiment of the present invention.

Referring to FIG. 7C, a software program corresponding to the Program_Rsp( ) is shown in the column “Field”, length of data in the software program is shown in the column “Length”, and format of data is shown in the column “format”.

According to the software program corresponding to the Program_Rsp( ), with respect to the broadcast program information request transmitted from the wireless transceiver 105, when a broadcast program is searched for by program name, the set-top box 103 can transmit broadcast program information of corresponding broadcast programs including real channel numbers, e.g., “channel_ID,” program identification, e.g., “program_ID,” reserved recording start time, e.g., “start_time,” reserved recording duration, e.g., “duration,” length of broadcast program title, e.g., “program_title_len,” and broadcast program title, e.g., “program_title( )”, to the wireless transceiver 105.

In addition, with respect to the broadcast program information request transmitted from the wireless transceiver 105, when a broadcast program is searched for by channel number, the set-top box 103 can transmit broadcast program information of corresponding broadcast programs including program identification, e.g., “program_ID,” reserved recording start time, e.g., “start_time,” reserved recording duration, e.g., “duration,” length of broadcast program title, e.g., “program_title_len,” and broadcast program title, e.g., “program_title( )”, to the wireless transceiver 105.

FIG. 7D is a view of a Program_Ack( ) according to an exemplary embodiment of the present invention.

Referring to FIG. 7D, the wireless transceiver 105 can transmit the Program_Ack_ID to the set-top box 103 to report whether or not the broadcast program information has been received.

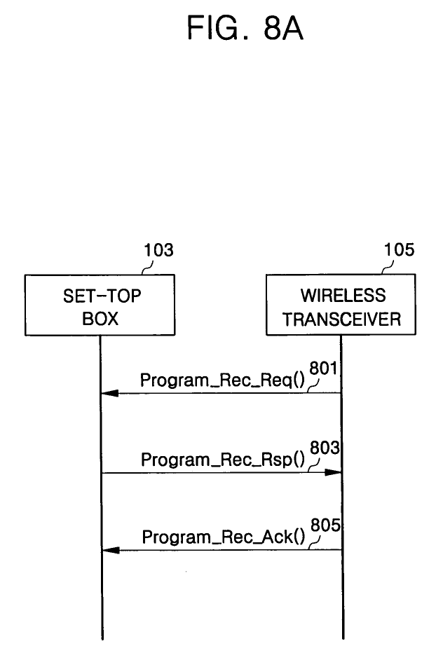

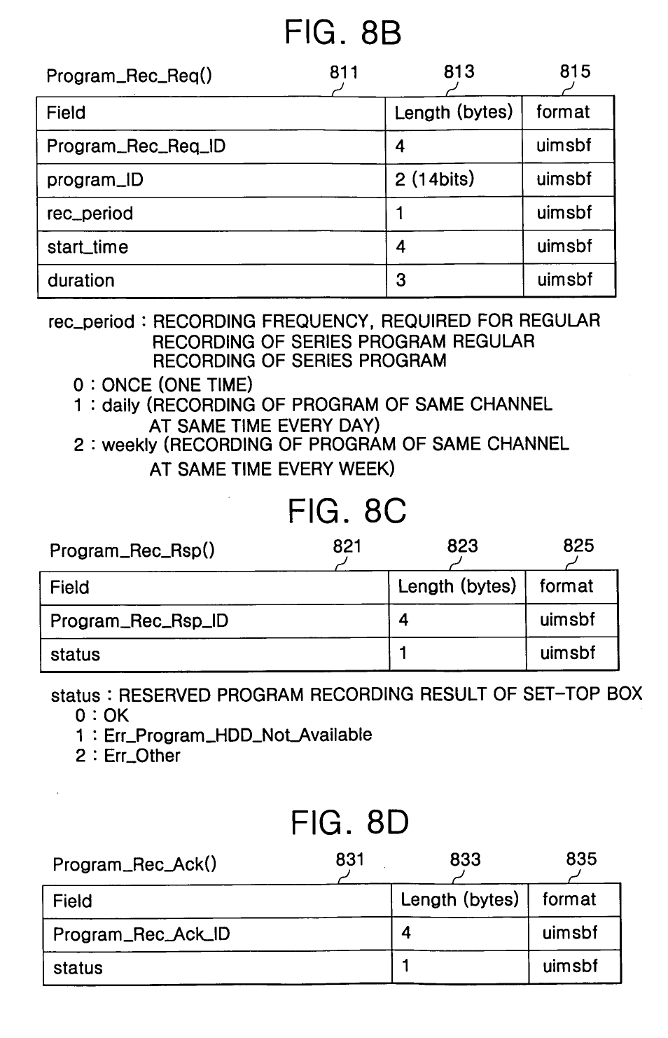

FIG. 8A is a view of a process of a set-top box 103 communicating with a wireless transceiver 105 to receive broadcast program information according to an exemplary embodiment of the present invention.

Referring to FIG. 8A, when a user of the wireless transceiver 105 requests a reserved recording of a broadcast program, the wireless transceiver 105 transmits a Program_Rec_Req( ) to the set-top box 103 (step 801). In response, the set-top box 103 sets up a reserved recording of the broadcast program corresponding to the user's request and then transmits a Program_Rec_Rsp( ) to the wireless transceiver 105 (step 803). Then, the wireless transceiver 105 transmits a Program_Rec_Ack( ) to the set-top box 103 to deliver a confirmation message (step 805).

FIG. 8B is a view of a Program_Rec_Req( ) according to an exemplary embodiment of the present invention.

Referring to FIG. 8B, a software program corresponding to the Program_Req( ) is shown in a column “Field”, length of data in the software program is shown in a column “Length”, and format of data is shown in the column “format”.

The software program corresponding to the Program_Rec_Req( ) includes information of program_ID corresponding to a broadcast program selected by a user of the wireless transceiver 105 for reserved recording, rec_frequency corresponding to recording frequency, start_time corresponding to recording start time, and duration corresponding to recording duration.

FIG. 8C is a view of a Program_Rec_Rsp( ) according to an exemplary embodiment of the present invention.

Referring to FIG. 8C, the set-top box 103 reports a reserved recording set up result for a broadcast program to the wireless transceiver 105 through status information of a software program corresponding to the Program_Rec_Rsp( ). For example, status information of 0 means that a reserved recording of a broadcast program has been set up normally.

FIG. 8D is a view of a Program_Rec_Ack( ) according to an exemplary embodiment of the present invention.

Referring to FIG. 8D, the wireless transceiver 105 transmits the Program_Rec_Ack_ID to the set-top box 103 to report whether or not information of the Program_Rec_Rsp( ) has been received.

As stated above, the system and method for reserved recording of a broadcast program according to the present invention transmits simple EPG information to a wireless transceiver 105 such as a remote controller without having to turn on the TV. Accordingly, a user can easily reserve recording of a broadcast program with simple button manipulation.

In addition, a set-top box 103 capable of reserved recording can process received broadcast program information and transmit it to a wireless transceiver 105 to display it in text format.

In addition, it is possible to improve power manageability of a TV, avoid the annoyance of channel changing, and reduce power consumption.

While the present invention has been described with reference to exemplary embodiments thereof, it will be understood by those skilled in the art that various modifications in form and detail can be made therein without departing from the scope of the present invention as defined by the following claims.

What is claimed is:

1. A system comprising:
a set-top box adapted to store broadcast program information and to set up a reserved recording of the broadcast program in response to a reserved recording request; and
a wireless transceiver adapted to receive the broadcast program information from the set-top box and to display the received broadcast program information on a display, and to generate a reserved recording request signal including information of the broadcast program selected by a user for reserved recording and to transmit the generated reserved recording request signal to the set-top box.

2. The system according to claim 1, wherein the set-top box comprises:
a first module adapted to encode and then transmit a broadcast program information signal to the wireless transceiver, and to receive and then decode the reserved recording request signal;
a second module adapted to store broadcast program information corresponding to the broadcast program information signal encoded by the first module and to transmit it to the wireless transceiver; and
a third module adapted to set up the reserved recording of a broadcast program corresponding to the reserved recording request signal received from the wireless transceiver and decoded by the first module.

3. The system according to claim 1, wherein the wireless transceiver comprises:
a first module adapted to receive a broadcasting information signal from the set-top box and to decode the received signal, and to encode the reserved recording request signal and to transmit the encoded signal to the set-top box;
a second module adapted to store the broadcast program information signal received from the set-top box and decoded by the first module;
a third module adapted to display broadcast program information corresponding to the broadcast program information signal stored in the second module on the display; and
a fourth module adapted to receive information of the broadcast program selected by the user of the wireless transceiver for reserved recording from among the broadcast program information displayed on the display by the third module.

4. The system according to claim 1, wherein the wireless transceiver comprises one of an infrared remote controller, a cellular telephone, and a Personal Digital Assistant (PDA).

5. The system according to claim 1, wherein the wireless transceiver employs one of a Wireless Local Area Network (WLAN), a Bluetooth system, and an Ultra Wide Band (UWB) system.

6. The system according to claim 1, wherein the broadcast program information comprises Electronic Program Guide (EPG) information.

7. The system according to claim 1, wherein the information of the broadcast program selected by the user for reserved recording comprises at least one of a reserved recording program identification, a recording frequency, a reserved recording start time, and a reserved recording duration.

8. A set-top box comprising:
a first module adapted to encode a broadcast program information signal and to transmit the encoded signal to a wireless transceiver, and to receive and decode a reserved recording request signal from the wireless transceiver;
a second module adapted to store broadcast program information corresponding to the broadcast program information signal encoded by the first module and transmitted to the wireless transceiver; and
a third module adapted to set up a reserved recording of a broadcast program corresponding to the reserved recording request signal received from the wireless transceiver and decoded by the first module.

9. A wireless transceiver comprising:
a first module adapted to receive a broadcasting information signal from a set-top box and to decode the received signal, and to encode a reserved recording request signal and to transmit the encoded signal to the set-top box;
a second module adapted to store the broadcast program information signal received from the set-top box and decoded by the first module;
a third module adapted to display broadcast program information corresponding to the broadcast program information signal stored in the second module on a display; and
a fourth module adapted to receive information of a broadcast program selected by a user of the wireless transceiver for reserved recording from among the broadcast program information displayed on the display by the third module.

10. A method comprising:
generating, at a wireless transceiver, a broadcast program information request signal and transmitting the generated signal to a set-top box in response to a program search request input by a user;
transmitting, at the set-top box, broadcast program information to the wireless transceiver in response to the broadcast program information request signal;
outputting, at the wireless transceiver, the received broadcast program information on a display portion;
receiving, at the wireless transceiver, information of a broadcast program selected by the user for reserved recording, generating a reserved recording request signal, and transmitting the generated signal to the set-top box; and
setting up, at the set-top box, reserved recording of the broadcast program corresponding to the reserved recording program information included in the reserved recording request signal.

11. The method according to claim 10, wherein the program search request is effected by one of a program name and a channel number.

12. The method according to claim 10, wherein the broadcast program information comprises EPG information.

13. The method according to claim 10, wherein the broadcast program information is displayed on the display of the wireless transceiver in a text format.

14. The method according to claim 10, wherein the reserved recording program information comprises at least one of a reserved recording program identification, a recording frequency, a reserved recording start time, and a reserved recording duration.

15. A method comprising:
generating a broadcast program information request signal and transmitting the generated signal to a set-top box in response to a program search request input by a user of a wireless transceiver;
receiving broadcast program information from the set-top box;
displaying the received broadcast program information on a display;
receiving information of a broadcast program selected by the user of the wireless transceiver for reserved recording from among the broadcast program information displayed on the display, and generating a reserved recording request signal and transmitting the generated signal to the set-top box; and
setting a reserved recording of the broadcast program corresponding to the reserved recording program information included in the transmitted reserved recording request signal by the set-top box.

16. A method comprising:
receiving a broadcast program information request signal from a wireless transceiver;
extracting information of a broadcast program corresponding to the broadcast program information request signal from a program information database prepared in advance;
transmitting the extracted broadcast program information to the wireless transceiver;
receiving a reserved recording request signal from the wireless transceiver, the reserved recording request signal being generated on the basis of information of a broadcast program selected by a user of the wireless transceiver for reserved recording from among the transmitted broadcast program information; and
setting up reserved recording of the broadcast program corresponding to the reserved recording program information included in the received reserved recording request signal.
